(19) United States
(12) Patent Application Publication
(10) Pub. No.: US 2016/0236229 A1
(43) Pub. Date: Aug. 18, 2016

(54) APPARATUS FOR REPAIRING DAMAGE TO VEHICLE PAINTWORK

(71) Applicant: Austin John Essam, Eastbourne (GB)

(72) Inventor: Austin John Essam, Eastbourne (GB)

(21) Appl. No.: 14/621,480

(22) Filed: Feb. 13, 2015

(51) Int. Cl. B05C 11/10; B05C 21/00; B05D 5/00; B05C 9/10

(52) U.S. Cl. CPC B05C 11/1015; B05C 9/10; B05C 21/00; B05D 5/005

(57) ABSTRACT

A standalone, independent of a computer network or system, self determining, automated apparatus for repairing damage to vehicles paintwork, by using a laser to alter the colour of a deposited paint layer, that is mixed to match that of an original colour specification at the time of manufacture, and to match that colour to a surrounding aged existing colour, and a means of harvesting particles of an existing paint colour layer to achieve a repair.

A standalone, independent of a computer network or system, self determining, automated apparatus for repairing damage to vehicles paintwork, by using a laser to after the colour of a deposited paint layer, that is mixed to match that of an original colour specification at the time of manufacture, and to match that colour to a surrounding aged existing colour, and a means of harvesting particles of an existing paint colour layer to achieve a repair.

Because of the difficulties of colour matching new paintwork with existing paintwork the repair process requires the paint to be mixed to the existing specification/colour and then applied to the surface, problems occur with this method to get an exact colour match due to the ageing of the existing paintwork. Current professional methods of repairing small areas of damaged paintwork involve the colour matching and painting of complete panels at the same time feathering paint onto adjacent panels; this is wasteful in terms of energy, materials and resources. Other methods involve applying small amounts of paint by brush or other means until the paint cures, several iterations of this process are required until the paint applied is above the level of existing paintwork and then needs rubbing back using abrasive papers until the desired finish is achieved, this method is very time consuming and the amateur repairer may not achieve a good finish.

Whilst the invention described uses vehicle paint as an example, the processes described could be used for a means to repair/change the structure of other surfaces. Also the scale of the invention whilst being described for small areas such as stone chips could be scaled up to a means to repair larger areas.

The basic unit (FIG. 3) uses colour matched paint along with the laser to achieve the repair.

Whilst the basic unit invention (FIG. 3) described is colour match paint means to complete the repair; the invention in an enhanced version (FIG. 4) utilises methods of harvesting some of the vehicles existing paint colour layer to achieve the repair.

The invention will now be described solely by way of example and with reference to the accompanying drawings.

FIG. 1 indicates a flat area of damage to paintwork.

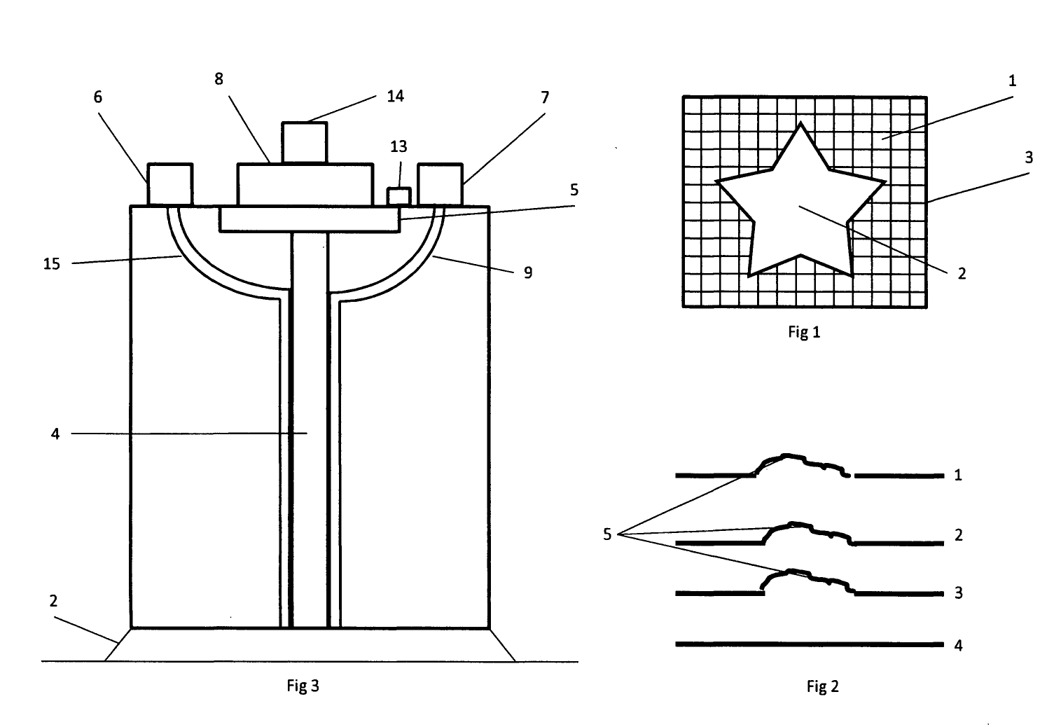

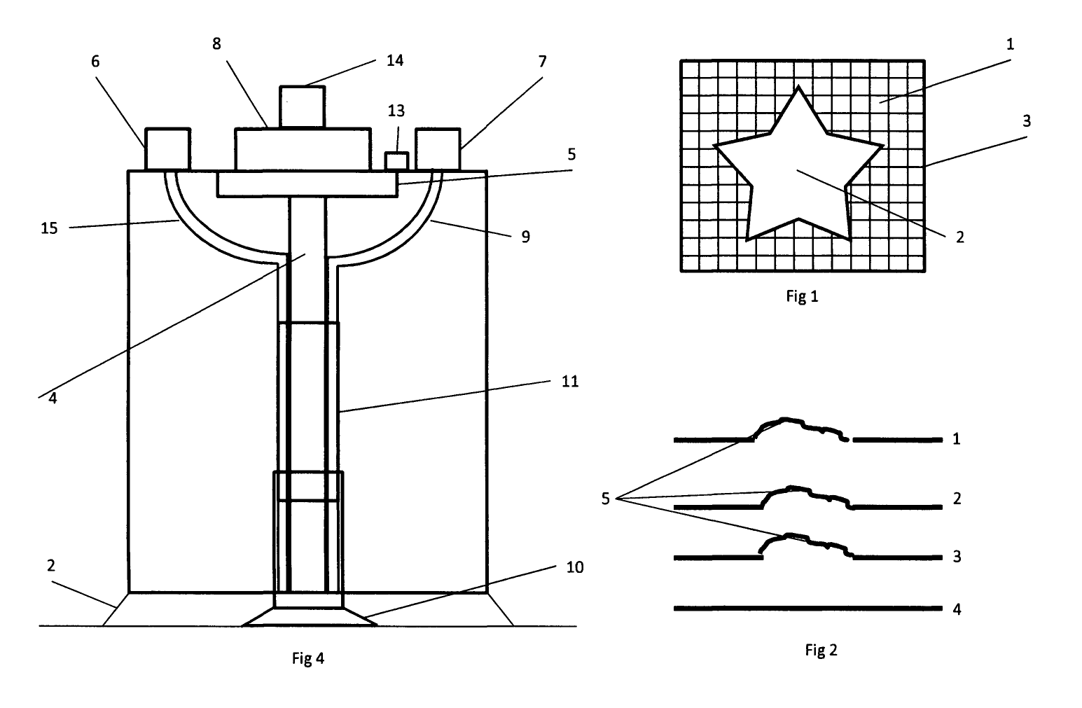

FIG. 2 raised area caused by impact damage.

FIG. 3 the basic unit.

FIG. 4 the enhanced unit.

The Basic Unit (FIG. 3)

The device is attached over the damaged area by supporting devices not shown, this could be for instance by suction cups attached to adjustable arms. The area to be worked on is sealed by the seal (2) (FIG. 3). Power is connected to the power supply connector (14) (FIG. 3) the unit is powered on by pressing an illuminated on/off button (13) (FIG. 3). The laser (4) (FIG. 3) by means of the laser positioning system (5) (FIG. 3) begins to scan the area to determine a consistent flat layer of colour matched undamaged paintwork and its colour composition (1) (FIG. 1) creating a map of the damaged area (2) (FIG. 1) and colour composition of the colour layer (1) (FIG. 1)to be stored in the Central Processing Unit (CPU) (8) (FIG. 3) as a digital map, represented by (3) (FIG. 1) an alternative means could be the unit could scan for abnormal areas of colour. The CPU (8) (FIG. 3) instructs the laser (4) (FIG. 3) by means of the laser positioning system (5) (FIG. 3) to scan using the digital map already stored in the CPU (8) (FIG. 3) represented by (3) (FIG. 1) for raised areas creating a raised digital map in the CPU (8) (FIG. 3) of the damaged area (5) (FIG. 2). The CPU (8) (FIG. 3) instructs the laser (4) (FIG. 3) by means of the laser positioning system (5) (FIG. 3) from the data stored in the CPU (8) (FIG. 3) to remove/burn off the raised damaged area (5) (FIG. 2). The CPU (8) (FIG. 3) instructs the laser (4) (FIG. 3) by means of the laser positioning system (5) (FIG. 3) to scan to determine the depth of the base layer (3) (FIG. 2) colour layer (2) (FIG. 2) and lacquer layer (1) (FIG. 2) recording this data as a digital map in the CPU (8) (FIG. 3). The laser (4) (FIG. 3) by means of the laser positioning system (5) (FIG. 3) and using the data stored in the CPU (8) (FIG. 3) removes an area of lacquer beyond the damaged area (2) (FIG. 1). The laser positioning system (5) (FIG. 3) moves to present flexible pipe (15) (FIG. 3) to a position above the damaged area determined from the digital map held in the CPU (8) (FIG. 3). Solenoid valve (6) (FIG. 3) via pipe (15) (FIG. 3) deposits a colour matched layer of paint via a reservoir (not shown) to the damaged area (2) (FIG. 1) several iterations of this process may be required before the area is covered, the laser (4) (FIG. 3) via the laser positioning system (5) (FIG. 3) continuously checking for cover until the original height of the colour layer is matched. The CPU (8) (FIG. 3) instructs the laser to cure the paint and remove/burn off any leftover base layer paint from the undamaged paintwork area (1) (FIG. 1) this process may involve several iterations the laser (4) (FIG. 3) via the laser positioning system (5) (FIG. 3) continuously checking for cover. The CPU (8) (FIG. 3) instructs the laser (4) (FIG. 3) via the laser positioning system (5) (FIG. 3) to scan for a colour match against the surrounding paint area existing colour (1) (FIG. 1). Dependant on the match the laser (4) (FIG. 3) by means of the laser and the positioning system (5) (FIG. 3) could lighten or darken the colour area to match the existing scanned colour (1) (FIG. 1). The laser positioning system (5) (FIG. 3) moves to present flexible pipe (9) (FIG. 3) to a position above the damaged area determined from the digital map in the CPU (8) (FIG. 3) solenoid valve (7) (FIG. 3) via flexible pipe (9) (FIG. 3) deposits a layer of lacquer via a reservoir (not shown) to the finished painted area. The CPU (8) (FIG. 3) instructs the laser (4) (FIG. 3) by means of the laser positioning system (5) (FIG. 3) to level the area of lacquer previously determined from the digital map held in CPU (8) (FIG. 3) and cure the lacquer layer (1) (FIG. 2). The process is completed when the on/off button indicator (13) (FIG. 3) changes colour to indicate to the operator when to remove the unit.

The Enhanced Unit (FIG. 4)

FIG. 1 indicates'a flat area of damage to paintwork, FIG. 2 raised area caused by impact damage.

The embodiment of the invention utilises methods of harvesting some of the vehicles existing paint colour layer (1) (FIG. 1) to achieve the repair and is known as The Enhanced Unit (FIG. 4) and is described below:

The device is attached over the damaged area by supporting devices not shown, this could be for instance by suction cups attached to adjustable arms. The area to be worked on is sealed by the seal (2) (FIG. 4). Power is connected to the power supply connector (14) (FIG. 4) the unit is powered on by pressing an illuminated on/off button (13) (FIG. 4). The laser (4) (FIG. 4) by means of the laser positioning system (5) (FIG. 4) begins to scan the area to determine a consistent flat layer of colour matched undamaged paintwork and its colour composition (1) (FIG. 1) creating a map of the damaged area (2) (FIG. 1) and colour composition of the colour layer (1) (FIG. 1) to be stored in the Central Processing Unit (CPU) (8) (FIG. 4) as a digital map represented by (3) (FIG. 1) an alternative means could be the unit could scan for abnormal areas of colour. The CPU (8) (FIG. 4) instructs the laser (4) (FIG. 4) by means of the laser positioning system (5) (FIG. 4) to scan using the digital map already stored in the CPU (8) (FIG. 4) represented by (3) (FIG. 1) for raised areas creating a raised digital map in the CPU (8) (FIG. 4) of the damaged area (5) (FIG. 2). The CPU (8) (FIG. 4) instructs the laser (4) (FIG. 4) by means of the laser positioning system (5) (FIG. 4) from the data stored in the CPU (8) (FIG. 4) to remove/burn off the raised damaged area shown in (5) (FIG. 2). The CPU (8) (FIG. 4) instructs the laser (4) (FIG. 4) by means of the laser positioning system (5) (FIG. 4) to scan to determine the depth of the base layer (3) (FIG. 2) colour layer (2) (FIG. 2) and lacquer layer (1) (FIG. 2) recording this data as a digital map in the CPU (8) (FIG. 4). The laser (4) (FIG. 4) by means of the laser positioning system (5) (FIG. 4) and using the data stored in the CPU (8) (FIG. 4) removes an area of lacquer beyond the damaged area (2) (FIG. 1). The particle collector (10) (FIG. 4) which consists of multiple separate sections is now charged and lowered by the linear motor mechanism (11) (FIG. 4) The laser (4) (FIG. 4) by means of the laser positioning system (5) (FIG. 4) removes small particles of the colour layer surrounding the damaged area (2) (FIG. 1) the small particles of colour layer being attracted to the now charged collector (10) (FIG. 4) on completion the particle collector (10) (FIG. 4) is raised by the linear motor (11) (FIG. 4). The laser positioning system (5) (FIG. 4) moves to present flexible pipe (15) (FIG. 4) to a position above the damaged area represented by (3) (FIG. 1) determined from the digital map held in the CPU (8) (FIG. 4). Solenoid valve (6) (FIG. 4) via pipe (15) (FIG. 4) deposits a base layer of paint via a reservoir (not shown) to the damaged area (2) (FIG. 1) several iterations of this process may be required before the area is covered, the laser (4) (FIG. 4) via the laser positioning system (5) (FIG. 4) continuously checking for cover until the area is covered to a depth just below the existing colour layer (1) (FIG. 2). The CPU (8) (FIG. 4) instructs the laser (4) (FIG. 4) by means of the laser positioning system (5) (FIG. 4) to cure the base layer paint level and remove/bum off any leftover base layer paint from the undamaged paintwork area (1) (FIG. 1). The particle collector (10) (FIG. 4) is lowered to the paint surface by means of the linear motor mechanism (11) (FIG. 4). The laser positioning system (5) (FIG. 4) moves the particle collector (10) (FIG. 4) so that sections of the particle collector (10) (FIG. 4) are positioned above the damaged area (2) (FIG. 1) and that section of the charged particle collector (10) (FIG. 4) is switched off allowing the recovered particles to collect on the paint surface (2) (FIG. 1) iterations of this process continue until all sections are discharged and the area covered. The CPU (8) (FIG. 4) instructs the laser (4) (FIG. 4) and the laser positioning system (5) (FIG. 4) to liquefy the particles on to the base paint layer (3) (FIG. 2) the laser (4) (FIG. 4) via the laser positioning system (5) (FIG. 4) continuously checking for cover, several iterations of the above processes may be necessary to achieve the desired cover. The CPU (8) (FIG. 4) instructs the laser (4) (FIG. 4) and the laser positioning system (5) (FIG. 4) to scan for a colour match against the surrounding paint area existing colour (1) (FIG. 1). Dependant on the match the laser (4) (FIG. 4) by means of the laser positioning system (5) (FIG. 4) could lighten or darken the colour area to match the existing scanned colour (1) (FIG. 1). The laser positioning system (5) (FIG. 4) moves to present flexible pipe (9) (FIG. 4) to a position above the damaged area (2) (FIG. 1) determined from the digital map in the CPU (8) (FIG. 4) solenoid valve (7) (FIG. 4) via flexible pipe (9) (FIG. 4) deposits a layer of lacquer via a reservoir (not shown) to the finished painted area. The CPU (8) (FIG. 4) instructs the laser (4) (FIG. 4) by means of the laser positioning system (5) (FIG. 4) to level the area of lacquer'previously determined from the digital map held in CPU (8) (FIG. 4) and cure the lacquer layer. The process is completed when the on/off button indicator (13) (FIG. 4) changes colour to indicate to the operator when to remove the unit.

It should be noted that whilst the description describes the methods above, the sequence of actions or level of equipment can be varied and steps introduced or removed to achieve the desired results. Whilst the paint harvesting method is described as a charged device, other means of harvesting the existing paint could be utilized. The term liquefy by the laser could also be replaced by other means such as chemicals to make changes to the collected colour layer paints structure or move the paint collected off the collector. Further enhancements to the digital map could be by adding a third dimension view to the existing 2 dimension flat and raised areas of damage. Damage to the substrate (4) (FIG. 2) can be catered for in the depth of the base layer paint applied.

What is claimed is:

1. A standalone, independent of a computer network or system, self determining, automated apparatus for repairing damage to vehicles paintwork, by using a laser to alter the colour of a deposited paint layer, that is mixed to match that of an original colour specification at the time of manufacture, and to match that colour to a surrounding aged existing colour, and a means of harvesting particles of an existing paint colour layer to achieve a repair.

2. Apparatus as claimed in 1 to analyse the colour composition of a colour layer.

3. Apparatus as claimed in 2 including a means to deposit an original colour matched paint and adjust the colour as necessary to match the colour of a surrounding aged colour layer.

4. Apparatus as claimed in 1 including a means to store harvested particles of an existing colour layer from around the damaged area.

5. Apparatus as claimed in 4 including a means to deposit the harvested colour layer to the repair area.

6. Apparatus as claimed in 4 including a means to liquefy the harvested colour layer.

7. Apparatus as claimed in 1 including a means to measure a flat area of damage and store the data in a digital map.

8. Apparatus as claimed in 7 including a means to raise the flat area of damaged area to a level defined in a digital map.

9. Apparatus as claimed in 1 including a means to measure a raised area of damage and store the data in a digital map.

10. Apparatus as claimed in 9 including a means to smooth the raised damage to the existing paintwork level defined in a digital map.

11. Apparatus as claimed in 3 including a means to cure the aged matched paint.

12. Apparatus as claimed in 3 including a means to deposit lacquer to a surface area defined in the digital map.

13. Apparatus as claimed in 12 including a means to cure the deposited lacquer in an area defined in a digital map.
